(19) United States
(12) Patent Application Publication
(10) Pub. No.: US 2026/0086284 A1
(43) Pub. Date: Mar. 26, 2026

(54) CHEMICAL BLOCKS FOR SILICON PHOTONIC WAVEGUIDES

(71) Applicant: Openlight Photonics, Inc., Goleta, CA (US)

(72) Inventors: Aditya Singh Malik, Goleta, CA (US); Erik Johan Norberg, Santa Barbara, CA (US); Enxiao Luan, Vancouver (CA); Jared Bauters, Santa Barbara, CA (US)

(21) Appl. No.: 18/891,293

(22) Filed: Sep. 20, 2024

(51) Int. Cl. G02B 6/122; G02B 6/12; G02B 6/136

(52) U.S. Cl. CPC G02B 6/1228; G02B 6/136; G02B 2006/121; G02B 2006/12176

(57) ABSTRACT

A silicon photonic device includes a semiconductor structure and a silicon-based substrate. The substrate is bonded to the semiconductor structure and patterned to comprise a waveguide, a raised structure, and a chemical barrier structure. A channel is defined between the raised structure and the waveguide, such that the semiconductor structure encloses the channel in a first direction and defines a mouth of the channel. The mouth opening in a second direction perpendicular to the first direction. The chemical barrier structure is positioned to prevent ingress of liquid into at least a portion of the channel via the mouth.

### TECHNICAL FIELD

The present disclosures relate to silicon photonics and, in some examples, to methods and systems to prevent chemical contamination in hybrid silicon photonic devices with bonded semiconductor materials.

### BACKGROUND

Silicon photonic devices integrate optical components and electronic circuits on silicon substrates. This technology leverages semiconductor manufacturing processes to create photonic integrated circuits (PICs) that can manipulate light at the micro-and nano-scale.

In recent years, there has been growing interest in hybrid silicon photonic devices, which combine silicon with other semiconductor materials to enhance functionality. These hybrid devices often involve bonding compound semiconductor materials, such as III-V materials, to silicon waveguides. This approach allows for the integration of active optical components, like lasers and amplifiers, with passive silicon photonic structures.

The fabrication of hybrid silicon photonic devices presents several challenges, including during various etching, epitaxial growth, bonding, and postprocessing steps. As the complexity of silicon photonic circuits increases and the dimensions of optical components continue to shrink, addressing these fabrication challenges becomes increasingly important for advancing the capabilities of hybrid silicon photonic devices.

### BRIEF DESCRIPTION OF THE SEVERAL VIEWS OF THE DRAWINGS

The following description includes discussion of figures having illustrations given by way of example of implementations of embodiments of the disclosure. The drawings should be understood by way of example, and not by way of limitation. As used herein, references to one or more “examples” or “embodiments” are to be understood as describing a particular feature, structure, or characteristic included in at least one implementation of the inventive subject matter, in at least some circumstances. Thus, phrases such as “in one example”, “in some examples”, “in some embodiments”, “in one embodiment” or “in an alternate embodiment” appearing herein describe various embodiments and implementations of the inventive subject matter, and do not necessarily all refer to the same embodiment. However, they are also not necessarily mutually exclusive. To easily identify the discussion of any particular element or act, the most significant digit or digits in a reference number may refer to the figure (“FIG.”) number in which that element or act is first introduced.

FIG. 1 is a top view of a first hybrid silicon photonic device with a waveguide defined by two channels in which one channel is contaminated by a liquid.

FIG. 2 is a cross-sectional view through line A-A of FIG. 1.

FIG. 3 is a top view of a second hybrid silicon photonic device with chemical barrier structures perpendicular to the waveguide, according to some examples.

FIG. 4A is a top view of a third hybrid silicon photonic device with chemical barrier structures in the first channel at 110 degree angles to the waveguide, according to some examples.

FIG. 4B is a top view of a fourth hybrid silicon photonic device with chemical barrier structures in the first channel at 70 degree angles to the waveguide, according to some examples.

FIG. 5 is a top view of a fifth hybrid silicon photonic device with chemical barrier structures with ends separated from the waveguide by gaps, according to some examples.

FIG. 6 is a flowchart illustrating a method for manufacturing a silicon photonic device having chemical barrier structures, according to some examples.

Descriptions of certain details and implementations follow, including a description of the figures, which may depict some or all of the embodiments described below, as well as discussing other potential embodiments or implementations of the inventive concepts presented herein. An overview of example embodiments of the disclosure is provided below, followed by a more detailed description with reference to the drawings.

### DETAILED DESCRIPTION

In the following description, for the purposes of explanation, numerous specific details are set forth in order to provide an understanding of various example embodiments of the inventive subject matter. It will be evident, however, to those skilled in the art, that example embodiments of the inventive subject matter may be practiced without these specific details. In general, well-known instruction instances, structures, and techniques are not necessarily shown in detail.

As noted above, the fabrication of hybrid silicon photonic devices presents several challenges. In particular, the bonding process and subsequent processing steps involve the use of various chemicals, including acids, bases, and organic compounds. These chemicals are necessary for etching, cleaning, and patterning the devices. However, the intricate structures of silicon photonic circuits, particularly the narrow channels and trenches between waveguides, can create difficulties in managing these chemicals during fabrication.

One of the ongoing challenges in this field is maintaining the integrity and performance of the optical structures throughout the manufacturing process. The interaction between the bonded materials and the silicon substrate, as well as the potential for chemical residues to affect device performance, requires careful consideration in device design and fabrication techniques.

Examples described herein relate to chemical blocks for silicon photonic waveguides. These structures address challenges in hybrid silicon photonic devices where compound semiconductor materials are bonded to silicon waveguides.

A typical fabrication process for hybrid silicon photonic devices involves several steps. Initially, a silicon wafer (formed from a silicon-based material, such as silicon or Silicon Nitride) is processed to create waveguide structures, typically by patterning one side or surface of the silicon wafer. These waveguides are typically raised elongate structures situated between depressed trenches or channels; the waveguides are used for confining light in the final silicon photonic circuit. After the silicon processing, a compound semiconductor structure (such as a multi-layered III-V semiconductor structure having successive layers of variously doped and/or undoped Indium Phosphide or other III-V materials, such as Indium Gallium Arsenide Phosphide or Indium Aluminum Gallium Arsenide) is bonded to the silicon substrate, either before or after singulating the silicon wafer into multiple discrete devices.

Following the bonding process, the edges of the compound semiconductor materials may need to be removed. This removal is often necessary because these edges often have damage from their preparation, such as mechanical cleaving and grinding, resulting in poorer material quality. The removal process can involve the use of acids and other wet chemicals.

A challenge arises during this removal process. The chemicals used can travel into the narrow channels etched into the surface of the silicon substrate and running beneath the bonded semiconductor material. These chemicals can become trapped and are not easily removed with further cleaning steps. The presence of these trapped chemicals can cause several problems, including optical loss and mechanical damage to the devices. For example, the liquid can optically interfere with the light travelling through waveguides adjacent to the channel where the liquid is trapped.

To address this technical problem, examples are described herein that introduce chemical barriers to silicon photonic device designs. The chemical barrier structures are designed to seal the mouths of the channels defined at the edges of the semiconductor structure without significantly impacting the optical performance of the waveguides.

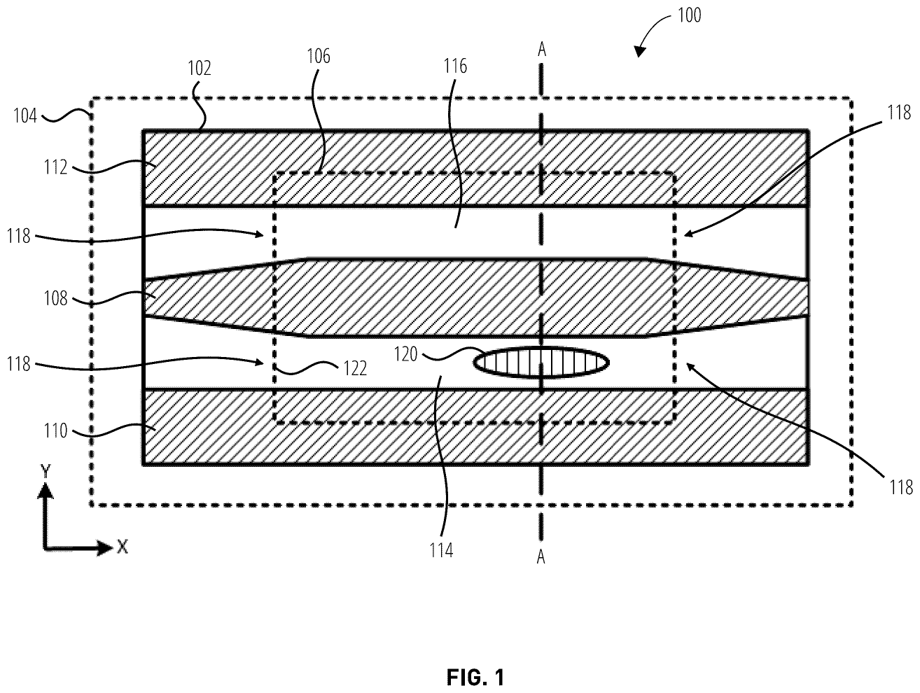

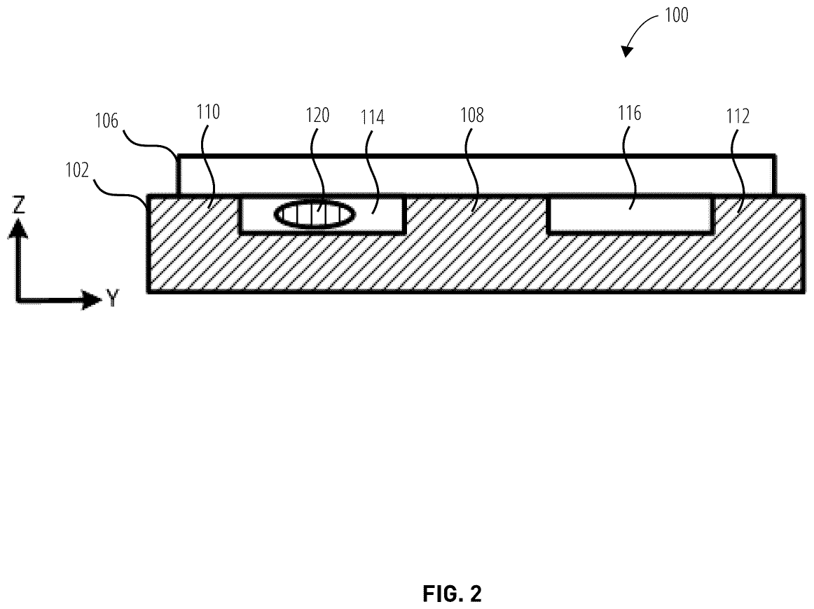

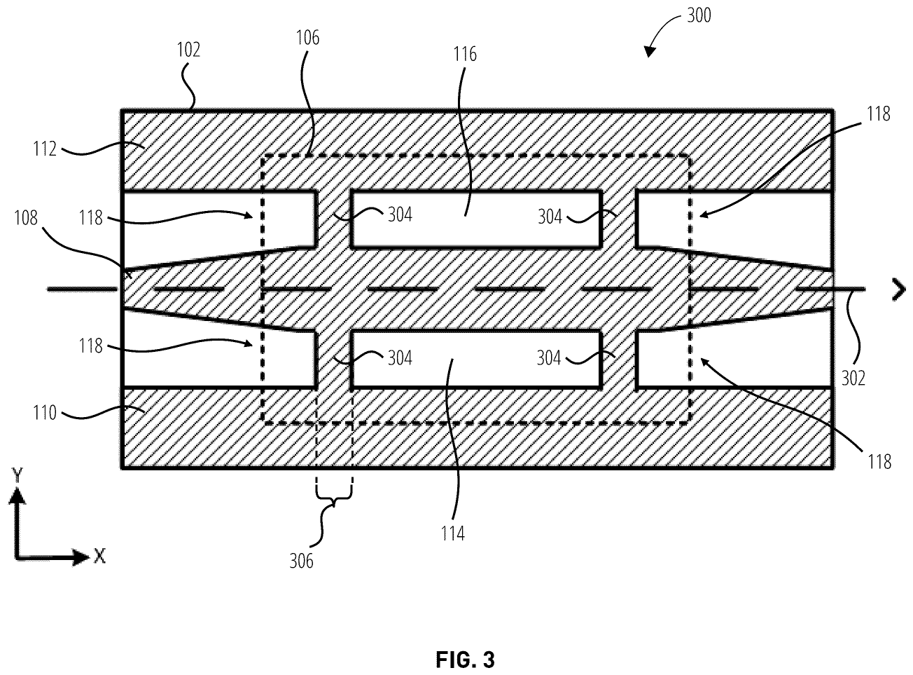

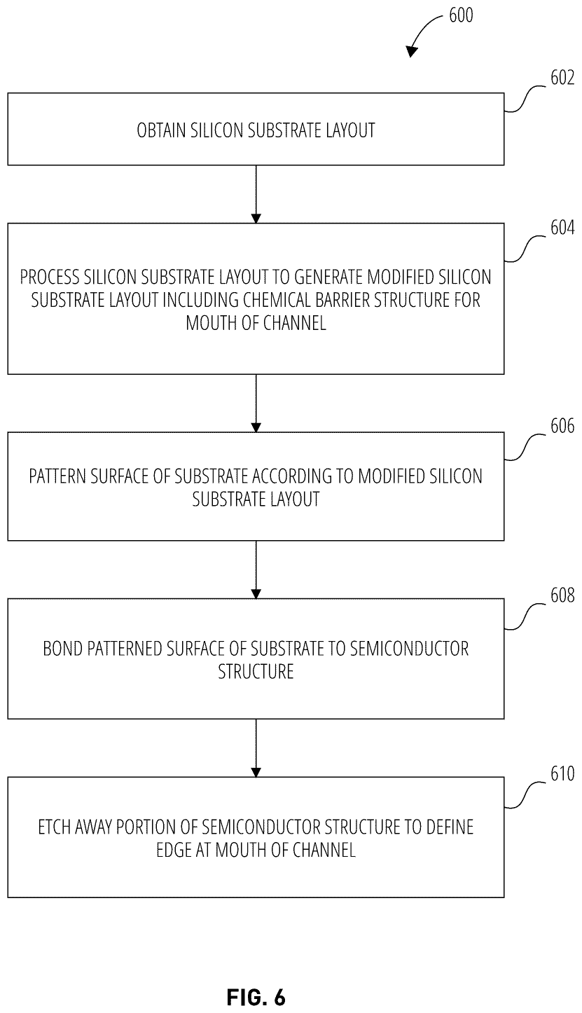

The chemical barrier structures come in several variations, each with its own characteristics and potential advantages. Examples are provided below with reference to FIG. 3 through FIG. 5. FIG. 1 and FIG. 2 illustrate the nature of the problem of liquid infiltration of the silicon substrate channels. FIG. 6 shows operations of an example method for manufacturing a silicon photonic device having chemical barrier structures.

The chemical barrier structures can be made of silicon, or a silicon-containing materials such as Silicon Nitride. In some examples, they are etched from the same substrate as the waveguide structures during the fabrication process. However, in some examples, the chemical barrier structures could also be made of a separate material, such as Silicon Nitride or Silicon Dioxide chemical barrier structures formed on a silicon substrate, and/or waveguides formed from Lithium Niobate, depending on the specific requirements of the photonic device.

The placement of these chemical barrier structures can affect their operation. They can be positioned within the channels, at or near the edges of the final footprint of the semiconductor structure, after chemical removal of damaged edges as described above. This placement can help to improve the degree of protection against chemical infiltration or ingress while mitigating or minimizing effects on the optical performance of the device.

The width and shape of the chemical barrier structures, their angle relative to the waveguide, and the presence and dimensions of any gap between the blocks and the waveguide can all play a role in determining their effectiveness in preventing chemical intrusion while maintaining optimal optical performance.

The chemical barrier structures described in these examples address a specific challenge in the fabrication of hybrid silicon photonic devices. By preventing the intrusion and trapping of chemicals in the narrow channels adjacent to bonded semiconductor materials and silicon waveguides, these structures aim to improve the yield and reliability of these devices. The various design options described herein provide flexibility in implementing these chemical barrier structures, allowing for optimization based on the specific requirements of different photonic devices.

While the primary focus of the described examples is on preventing damage from liquid chemicals such as acid etchants, the chemical barrier structures can also protect against other potential contaminants. These include bases used in developing photoresist and even the photoresist material itself, which is an organic compound applied multiple times during the fabrication process.

FIG. 1 shows a top-down plan view of a first silicon photonic device 100. The silicon photonic device 100 includes a silicon substrate 102 bonded to a semiconductor structure.

Whereas FIG. 1 shows a single waveguide 108, it will be appreciated that, in some examples, the silicon photonic device 100 as a whole can include multiple waveguides 108 and/or other silicon structures. The silicon photonic device 100 shown in FIG. 1 is an intentionally simplified device, as are the other example devices illustrated herein. In some examples, the devices shown herein can be understood to represent portions of larger and more complex devices. The manufacturing methods described herein can be understood to be applicable to multiple waveguides, channels, or regions on the surface of the silicon substrate 102 of such a larger device.

The silicon substrate 102 may be formed from a silicon-containing material, such as silicon or Silicon Nitride, and serves as the base for the photonic device 100. FIG. 1 shows a top-down view of a patterned surface of the silicon substrate 102, which has been etched or otherwise patterned to define depressed trenches, channels, and/or other depressions, with various raised structures, such as waveguides, thereby defined in relief.

Terms indicating verticality, such as “top”, “up”, “upper”, “high”, “raised”, and their antonyms and variants, as used herein, refer to the Z axis extending out of the plane of the drawing of FIG. 1 (and shown explicitly in FIG. 2 below). Horizontal terms refer to the X-Y plane parallel to the patterned surface of the silicon substrate 102 shown in top-down view, with X and Y axes, in FIG. 1. It will be appreciated that the actual orientation of the devices described herein is arbitrary as to how they are manufactured and used; the X, Y, and Z axes, and the vertical and horizontal terms used herein, are simply intended to provide a consistent frame of reference for the figures, description, and claims.

An initial semiconductor structure 104 is bonded to the silicon substrate 102 and may be formed from one or more compound semiconductor materials, such as a III-V semiconductor material. The surface of the semiconductor structure bonded to the silicon substrate 102 may be referred to herein as a first surface; the surface of the silicon substrate 102 bonded to the semiconductor structure may be referred to herein as a second surface. After bonding, portions of the initial semiconductor structure 104 are etched away or otherwise removed from some regions of the silicon substrate 102. The final semiconductor structure 106 represents the remaining portion of the initial semiconductor structure 104 after processing and metallization.

The waveguide 108 is formed on the silicon substrate 102 and may be composed of any suitable material, such as silicon or the same silicon-containing material as the silicon substrate 102. In some examples, the waveguide 108 is formed from the silicon substrate 102 through etching or other patterning techniques. Light propagates through the waveguide 108 in a generally longitudinal direction along the length of the waveguide 108, such as left to right and/or right to left through the waveguide 108 as illustrated. The waveguide 108 thereby guides light along a predetermined path within the photonic device 100.

The first raised structure 110 and the second raised structure 112 are positioned adjacent to the waveguide 108 on opposite sides. These raised structures may be formed from the same material as the substrate and serve to define the channels 114 and 116. First channel 114 is on a first side of the waveguide 108 and separates the waveguide 108 from the first raised structure 110. Second channel 116 is on a second side of the waveguide 108 and separates the waveguide 108 from the second raised structure 112. These channels 114 and 116 are necessary for confining light within the waveguide 108 in the final silicon photonic circuit.

After the semiconductor structure has been removed from one or more regions of the silicon substrate 102 through processing and edge removal, the final semiconductor structure 106 has an edge 122 at its left periphery. The bonded bottom surface (or first surface) of the final semiconductor structure 106 therefore confines or encloses the first channel 114 and second channel 116 in a first direction, toward the final semiconductor structure 106 (in this case, the positive Z direction extending out of the plane of the drawing). The edge 122 of the final semiconductor structure 106 also defines a mouth 118 of the first channel 114, which opens in a second direction (in this case, the negative X direction) that is perpendicular to the first direction towards the semiconductor structure (e.g., the positive Z direction). It will be appreciated that the edge 122 also defines a mouth 118 of the second channel 116 opening in the negative X direction, and the opposite (right) edge of the final semiconductor structure 106 defines another mouth 118 of the first channel 114 and another mouth 118 of the second channel 116, both opening in the positive X direction.

In this example, a liquid 120 is shown contaminating the first channel 114. The liquid 120 may represent chemicals used in the fabrication process, such as acids or other wet chemicals used to remove the edges of bonded semiconductor materials. The presence of this liquid 120 in the first channel 114 can cause optical loss and/or mechanical damage to the device.

FIG. 2 is a cross-sectional view through line A-A of FIG. 1. In FIG. 2, the plane of the drawing is the Y-Z plane, as opposed to the X-Y plane of FIG. 1.

The final semiconductor structure 106 is positioned above and bonded to the top surface of the silicon substrate 102, in the positive Z direction.

The waveguide 108 is shown as being formed from the silicon substrate 102. In this cross-sectional view, the waveguide 108 appears as a distinct raised structure extending from the substrate. The first raised structure 110 and the second raised structure 112 are visible on either side of the waveguide 108. These structures extend upward from the silicon substrate 102 and play a role in defining the channels 114 and 116 adjacent to the waveguide.

The first channel 114 and the second channel 116 are formed in the spaces between the raised structures 110 and 112 and the waveguide 108. These channels 114 and 116 are confined in the upward direction by the bottom surface of the final semiconductor structure 106. The mouths 118 of these channels (shown in FIG. 1) open in the positive and negative X directions, out of and into the plane of the drawing of FIG. 2, respectively.

In this cross-sectional view, the liquid 120 is shown occupying the first channel 114.

This liquid may represent chemicals used in the fabrication process, such as acids or wet etchants, which have intruded into the channel. The presence of this liquid, which can come into direct contact with either or both of the waveguide 108 and/or the final semiconductor structure 106, illustrates the potential for chemical-induced damage and optical performance degradation.

The dimensions and geometries of the components visible in this cross-sectional view can be selected to achieve specific optical and/or manufacturing objectives. For instance, the height of the waveguide 108, the height of the raised structures 110 and 112 relative to the waveguide 108, the depth of the channels 114 and 116, and the thickness of the final semiconductor structure 106 may all be tailored to support desired optical modes and wavelengths while facilitating the fabrication process. Thus, chemical barrier structures described herein may need to be shaped and positioned to accommodate various dimensions of these components selected for optical performance and/or manufacturability.

FIG. 1 and FIG. 2 are intended to illustrate the nature of the technical challenge addressed by the manufacture and use of chemical barrier structures, examples of which are described below with reference to FIG. 3 through FIG. 6.

FIG. 3 is a top-down plan view of a second hybrid silicon photonic device 300 with chemical barrier structures 304 arranged perpendicularly to the waveguide 108.

As shown in FIG. 3, the waveguide 108 has a longitudinal axis 302 representing the primary direction of light propagation through the waveguide 108. In this example, the longitudinal axis 302 extends from left to right; it will be appreciated that, in some use cases, the light can propagate primarily from right to left. In some examples, the waveguide 108 can be composed of a silicon-containing material (such as silicon) and can have dimensions optimized for specific optical modes and wavelengths across a range of 1000 nanometers (nm) to 2000 nm.

In this configuration, chemical barrier structures 304 are added to the layout of the silicon photonic device 300, extending between the waveguide 108 and the raised structures 110 and 112 to seal the mouths 118 of the first channel 114 and second channel 116. The chemical barrier structures 304 are shown in FIG. 3 as rectangles having a width 306 of approximately 200 nm or less, such as between 100nm and 200 nm. In some examples, the rectangles extend along the Z axis upward to the bottom surface of the final semiconductor structure 106 and downward to the bottom of the channels, thereby defining a wall-like structure that blocks the entire cross-sectional area of the channel. Thus, in this configuration, the chemical barrier structures 304 may be referred to as walls having a width 306 or thickness as measured, in the illustrated example, along the X axis.

The relatively narrow width 306 of the chemical barrier structures 304 can act to reduce or minimize disturbance to the optical mode propagating through the waveguide 108 while still providing an effective barrier against chemical intrusion. The etching of rectangular cross-section walls having a width of less than or equal to 200 nm is compatible with standard lithography tools used in the semiconductor industry.

The chemical barrier structures 304 shown in the silicon photonic device 300 are arranged to be perpendicular to the longitudinal axis 302 of the waveguide 108, at a 90 degree angle. The interface between each chemical barrier structure 304 and the waveguide 108 therefore forms a pair of right-angle corners at the left and right faces of the chemical barrier structure 304. The chemical barrier structures 304 are configured to prevent or substantially reduce chemical intrusion into the channels via the mouths 118. In some examples, the chemical barrier structure 304 may be formed from the same material as the silicon substrate 102 or from Silicon Nitride.

As shown, each chemical barrier structure 304 is positioned near a corresponding mouth 118, to prevent ingress of liquids into the central portion of the channel behind the chemical barrier structure 304. In some examples, multiple chemical barrier structures 304 may be implemented along the length of the waveguide 108 to provide further protection against chemical intrusion. The spacing and number of these structures may be optimized based on the specific device design and fabrication process requirements.

Simulations have been performed to evaluate the performance of the perpendicular chemical barrier structure design of silicon photonic device 300 of FIG. 3. Transmission and reflection characteristics have been analyzed for different widths of the chemical barrier structures 304, across different wavelengths of light. These simulations can assist in optimizing the design parameters to achieve the best balance between chemical protection and optical performance.

The simulation results have established several relevant observations. First, increased width 306 of the chemical barrier structures 304 tends to slightly reduce transmission of at least some wavelengths of light: whereas a width 306 of 0.3 microns results in over 98% transmission of light at a wavelength of 1310 nm, the transmission of light is slightly reduced as the width increases. Second, transmission is largely invariant across a range of different light wavelengths centered on 1310 nm: chemical barrier structures 304 having a width 306 of 0.3 microns maintain transmission rates of over 97.8% and reflection rates of under 0.0045% (4.5*e⁻⁵) over the 1260 nm to 1360 nm wavelength range. This means that, overall, some examples disclosed herein can be used to block chemical ingress into channels without significant effects on transmission (e.g., 97.8% or greater transmission) or reflection (e.g., less than 0.0045% reflection) in the 1260 nm to 1360 nm spectral range, or more generally in the 1000-2000 nm range.

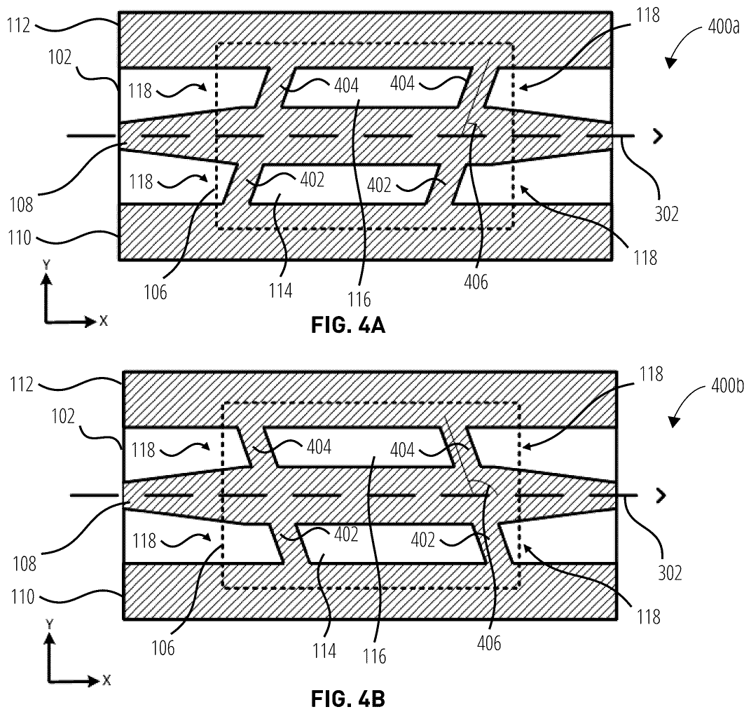

FIG. 4A is a top-down plan view of a third hybrid silicon photonic device 400a having first channel chemical barrier structure 402 in the first channel 114 arranged at 110 degree angles to the longitudinal axis 302 of the waveguide 108, and second channel chemical barrier structure 404 in the second channel 116 arranged at 70 degree angles to the longitudinal axis 302 of the waveguide 108. FIG. 4B is a top-down plan view of a fourth hybrid silicon photonic device 400b having first channel chemical barrier structure 402 in the first channel 114 arranged at 70 degree angles to the longitudinal axis 302 of the waveguide 108, and second channel chemical barrier structure 404 in the second channel 116 arranged at 1100 degree angles to the longitudinal axis 302 of the waveguide 108. The angle 406 of a second channel chemical barrier structure 404 to the longitudinal axis 302 is shown in each figure.

In some examples, as shown in FIG. 4A, the first channel chemical barrier structures 402 and second channel chemical barrier structures 404 are walls (similar to the wall-shaped chemical barrier structures 304 of the silicon photonic device 300 of FIG. 3) that are coplanar with each other, pairwise: a given first channel chemical barrier structure 402 in the first channel 114 is coplanar with a corresponding second channel chemical barrier structure 404 in the second channel 116 on the opposite side of the waveguide 108.

Using angled chemical barrier structures 304, positioned at non-right angles of between 70 degrees and 110 degrees, or between 60 degrees and 120 degrees, can provide advantages in some circumstances. The non-right angles can result in high transmission of light in the silicon waveguide crossing the block, similar to the transmission results described above with reference to silicon photonic device 300, while also deflecting any reflected light from the interface between the chemical barrier structure 304 and the waveguide 108 out of the waveguide 108.

In some examples, the angled orientation of the chemical barrier structures 402 and 404 can serve multiple purposes. Firstly, it may enhance the effectiveness of preventing chemical intrusion into the channels 114 and 116 via the mouths 118 by trapping the liquid in the corner having an acute angle: for example, in FIG. 4A, the corner formed between the left second channel chemical barrier structure 404 and the second raised structure 112, or between the right second channel chemical barrier structure 404 and the waveguide 108. Secondly, this configuration may help to deflect out of the waveguide 108 any reflected light from the interface between the chemical barrier structures and the waveguide 108, potentially reducing unwanted optical effects.

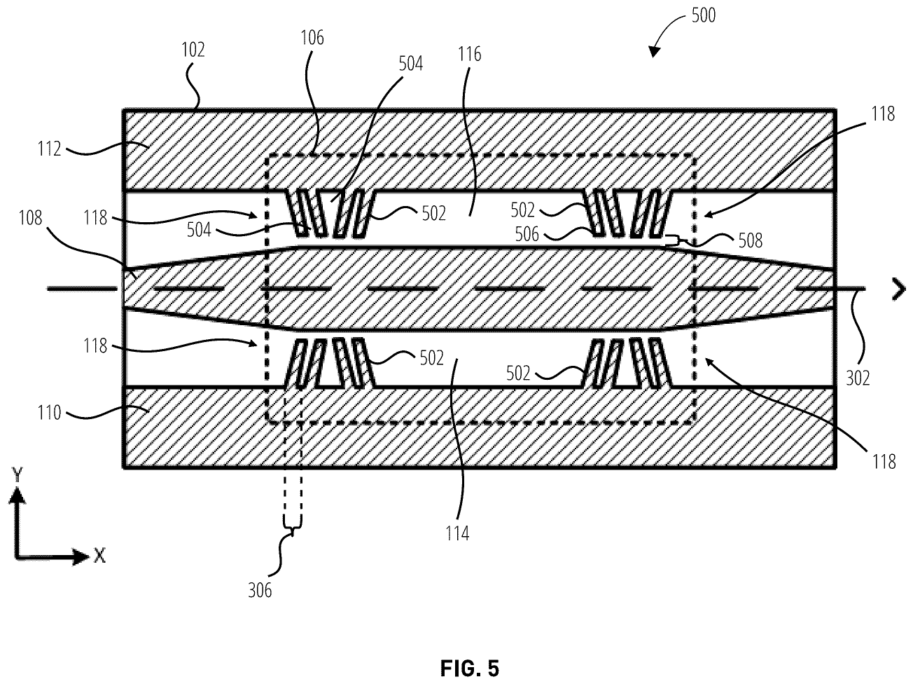

FIG. 5 is a top-down plan view of a fifth hybrid silicon photonic device 500 with chemical barrier structures formed as multiple protrusions 502 from the raised structures. The protrusions 502 extend from the raised structures to ends 506 positioned close to the waveguide 108 but separated from the edge of the waveguide 108 by gaps 508. Thus, the protrusions 502 do not contact the waveguide 108.

In some examples, the protrusions 502 can be arranged to prevent ingress of liquids into the channels while leaving the optical properties of the waveguide 108 unaltered. In the illustrated example, the protrusions 502 include, at each mouth 118 of each channel, two pairs of protrusions 502. Each pair of protrusions 502 has two protrusions 502 roughly parallel to each other. The two pairs at a given mouth 118 are arranged such that their ends converge near the same location at the edge of the waveguide 108. All four of the protrusions 502 at a given mouth 118 have ends 506 that are all roughly the same distance from the edge of the waveguide 108, separated by a common gap 508.

In some examples, the gap 508 is 100 nm or larger. The protrusions 502 can be shaped as rectangles (as in silicon photonic device 300, silicon photonic device 400a, and silicon photonic device 400b) or as tapered rectangles having a greater width at the base (where the protrusion 502 meets the raised structure 110 or 112) than at the end 506. In some examples, the end 506 can have a width 306 of 100 nm or more (to accommodate lithographic manufacturing), and the base may be the same width or wider.

In use, each pair of roughly parallel protrusions 502 defines between the two protrusions 502 a trap channel 504 configured to draw in liquid that comes into contact with the ends 506 of the two protrusions 502, trapping the liquid within the trap channel 504 and drawing the liquid away from the waveguide 108. In some examples, there may be a further trap channel 504 formed between the two pairs of protrusions 502 at a given mouth, shown as a roughly triangular shape in FIG. 5. The surface tension of the liquid can be leveraged to pull the liquid into the trap channels 504 through capillary action.

In some examples, as in the silicon photonic device 300, silicon photonic device 400a, and silicon photonic device 400b, the protrusions 502 of the silicon photonic device 500 can extend up and down along the Z axis to reach the final semiconductor structure 106 and silicon substrate 102, respectively. This results in wall-like protrusion 502 structures having the cross-sectional shapes shown in FIG. 5.

In some examples, the protrusions 502 can be arranged differently from the illustrated example. Only one pair of protrusions 502 can be used at a mouth 118, or more than two pairs of protrusions 502 can be used. The protrusions 502 can be arranged at a 90 degree angle, or any other suitable angle, to the longitudinal axis 302 instead of the angle shown in FIG. 5. Some examples can use protrusions 502 with varying gaps 508 between the waveguide 108 and the ends of the protrusions 502. Various examples can implement the protrusions 502 at a given mouth 118 as a set of two or more protrusions 502, defining between the protrusions 502 one or more trap channel 504, the ends of the protrusions 502 each being separated from the waveguide 108 by a respective gap 508. The specific geometry of the protrusions 502 may be optimized to balance chemical protection and optical performance. Regardless of their exact geometry, the protrusions 502 can act as chemical barrier structures preventing ingress of liquids into the central portion of the channel and preventing liquids from remaining in contact with the waveguides.

Because the protrusions 502 do not contact the waveguide 108, the silicon photonic device 500 may be able to trap liquids while leaving the optical properties of the waveguide 108, such as transmission and reflectance, unaffected.

FIG. 6 shows operations of a method 600 for manufacturing a silicon photonic device. The method 600 is automatically performed by a computer, thereby simplifying the design of layouts for patterning silicon substrates for use in silicon photonic devices. Automating in the placement of chemical barrier structures can simplify circuit design while addressing the technical problem of liquid infiltration into the channels of the silicon substrate. Because different photonic devices may require different configurations, an automated system (such as modified EDA software) could analyze the layout of the waveguides and the edges of the semiconductor structures to determine the optimal placement of the chemical barrier structures. This automation could help in efficiently implementing the chemical barrier structures across various device designs.

Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

According to some examples, the method 600 includes obtaining a silicon substrate layout at operation 602. The silicon substrate layout can be obtained from existing electronic design automation (EDA) software processes in some examples. The silicon substrate layout can be implemented as a data structure representative of the layout of a silicon photonic device, including placement of structures patterned into the silicon substrate 102 as well as the placement of semiconductor structures bonded to the top of the patterned surface of the silicon substrate 102 (e.g., final semiconductor structure 106).

According to some examples, the method 600 includes processing the silicon substrate layout to generate a modified silicon substrate layout to which one or more chemical barrier structures have been added at operation 604. The chemical barrier structures are added to the layout at locations intended to prevent liquid egress into one or more channels via one or more mouths thereof. In some examples, operation 604 includes automatically identifying channels etched into the silicon substrate 102, identifying where these channels are enclosed by semiconductor structures, and identifying the edges of the semiconductor structures and where these edges intersect the channels, thereby defining a mouth. For each mouth identified thereby, operation 604 can proceed to automatically identify a location within the channel near the mouth where a chemical barrier structure can be added. The type of chemical barrier structure (e.g., chemical barrier structure 304, first channel chemical barrier structure 402, second channel chemical barrier structure 404, or set of protrusions 502) can be selected based on various factors, potentially including channels and waveguide geometry, light wavelength, and optical requirements of the intended application. Finally, the chemical barrier structure can be positioned within the layout and added to the modified silicon substrate layout. This can be repeated for each mouth of each channel identified.

According to some examples, the method 600 includes patterning the surface of the silicon substrate 102 according to the modified silicon substrate layout at operation 606. The modified silicon substrate layout generated at operation 604 is used as input to a fabrication process. The fabrication process includes a patterning process, such as lithography and etching of the surface of the silicon substrate 102 to form waveguides, raised structures, channels, chemical barrier structures, and/or other structures. These are formed in accordance with the modified silicon substrate layout to include one or more chemical barrier structures.

According to some examples, the method 600 includes bonding the patterned surface of the silicon substrate 102 (as patterned at operation 606) to the surface of the semiconductor structure (e.g., initial semiconductor structure 104) at operation 608. The bonding operation 608 can be performed using flip-chip or other semiconductor-silicon wafer bonding techniques used in silicon photonic device fabrication.

According to some examples, the method 600 includes etching away a portion of the semiconductor structure (e.g., initial semiconductor structure 104) from one or more regions on the surface of the silicon substrate 102 to define an edge (such as edge 122) of the final semiconductor structure 106 at the mouth 118 of a channel (such as first channel 114) at operation 610. Because the silicon substrate 102 has been patterned near the mouth 118 to include a chemical barrier structure configured to prevent ingress of liquid into the channel via the mouth 118, the channel is protected against infiltration of acid etchants used to remove portions of the final semiconductor structure 106, and/or any other liquids at risk of such infiltration.

Other examples of optical devices, systems, and methods may include features, and combinations or subcombinations of features, of the various examples described herein.

In view of the disclosure above, various examples are set forth below. It should be noted that one or more features of an example, taken in isolation or combination, should be considered within the disclosure of this application.

In view of the disclosure above, various examples are set forth below. It should be noted that one or more features of an example, taken in isolation or combination, should be considered within the disclosure of this application.

In view of the disclosure above, various examples are set forth below. It should be noted that one or more features of an example, taken in isolation or combination, should be considered within the disclosure of this application.

Example 1 is a silicon photonic device, comprising: a semiconductor structure having a first surface; and a substrate formed from a silicon-containing material, the substrate having a second surface bonded to the first surface of the semiconductor structure and patterned to comprise: a waveguide; a raised structure defining a channel between the raised structure and the waveguide, such that the first surface encloses the channel in a first direction toward the semiconductor structure and defines a mouth of the channel, the mouth being open in a second direction perpendicular to the first direction; and a chemical barrier structure positioned to prevent ingress of liquid into at least a portion of the channel via the mouth.

In Example 2, the subject matter of Example 1, wherein: the chemical barrier structure comprises at least two protrusions extending from the raised structure to respective ends; the at least two protrusions define at least one trap channel between the protrusions; and the ends are separated from the waveguide by a gap, such that liquid passing into the channel via the mouth is drawn from the gap into the trap channel, away from the waveguide, by surface tension.

In Example 3, the subject matter of Example 2, wherein: the gap is at least 100 nm.

In Example 4, the subject matter of Examples 2-3, wherein: each protrusion of the at least two protrusions has a rectangular shape.

In Example 5, the subject matter of Examples 2-4, wherein: each protrusion of the at least two protrusions has a tapered shape with a greater width at the raised structure than at the end.

In Example 6, the subject matter of Examples 1-5, wherein: the chemical barrier structure comprises a wall extending between the raised structure and the waveguide.

In Example 7, the subject matter of Example 6, wherein: the wall has a thickness of no more than 200 nm.

In Example 8, the subject matter of Examples 6-7, wherein: the wall is a first wall; the first surface further defines a second mouth of the channel; and the second surface of the substrate is patterned to comprise a second chemical barrier structure positioned to prevent ingress of liquid into at least the portion of the channel via the second mouth, the second chemical barrier structure comprising a second wall parallel to the first wall.

In Example 9, the subject matter of Examples 6-8, wherein: light propagates through the waveguide along a longitudinal axis of the waveguide; and the wall extends from the waveguide at an angle of 60 to 120 degrees to the longitudinal axis.

In Example 10, the subject matter of Example 9, wherein: the angle is about 90 degrees.

In Example 11, the subject matter of Example 9, wherein: the angle is about 70 degrees or about 110 degrees.

In Example 12, the subject matter of Examples 9-11, wherein: the channel is a first channel; and the second surface of the substrate is patterned to comprise: a second raised structure defining a second channel between the second raised structure and the waveguide, the first channel and the second channel being located on opposite sides of the waveguide; and a second chemical barrier structure positioned to prevent ingress of liquid into at least a portion of the second channel, the second chemical barrier structure comprising a second wall, coplanar with the first wall and extending from the second raised structure to the waveguide.

In Example 13, the subject matter of Examples 1-12, wherein: the chemical barrier structure maintains optical performance of the waveguide across a wavelength range spanning 1000 nm to 2000 nm.

Example 14 is a computer-implemented method for manufacturing a silicon photonic device, comprising: obtaining a silicon substrate layout comprising a pattern for patterning a substrate formed from a silicon-containing material to form: a waveguide; and a raised structure defining a channel between the raised structure and the waveguide, such that the channel is enclosed in a first direction by a semiconductor structure, thereby defining a mouth of the channel, the mouth being open in a second direction perpendicular to the first direction; and processing the silicon substrate layout to generate a modified silicon substrate layout comprising: a chemical barrier structure formed from the substrate and positioned to prevent ingress of liquid into at least a portion of the channel via the mouth.

In Example 15, the subject matter of Example 14, further comprising: patterning a surface of the substrate according to the modified silicon substrate layout; and bonding the patterned surface of the substrate to a surface of the semiconductor structure.

In Example 16, the subject matter of Examples 14-15, further comprising: etching away a portion of the semiconductor structure to define an edge of the semiconductor structure at the mouth.

In Example 17, the subject matter of Examples 14-16, wherein: the chemical barrier structure comprises at least two protrusions extending from the raised structure to respective ends; the at least two protrusions define at least one trap channel between the protrusions; and the ends are separated from the waveguide by a gap, such that liquid passing into the channel via the mouth is drawn from the gap into the trap channel, away from the waveguide, by surface tension.

In Example 18, the subject matter of Examples 14-17, wherein: the chemical barrier structure comprises a wall extending between the raised structure and the waveguide.

In Example 19, the subject matter of Example 18, wherein: light propagates through the waveguide along a longitudinal axis of the waveguide; and the wall extends from the waveguide at an angle of 60 to 120 degrees to the longitudinal axis.

Example 20 is a non-transitory computer-readable storage medium, the computer-readable storage medium including instructions that when executed by a processor of a system, cause the system to perform operations comprising: obtaining a silicon substrate layout comprising a pattern for patterning a substrate formed from a silicon-containing material to form: a waveguide; and a raised structure defining a channel between the raised structure and the waveguide, such that the channel is enclosed in a first direction by a semiconductor structure, thereby defining a mouth of the channel, the mouth being open in a second direction perpendicular to the first direction; and processing the silicon substrate layout to generate a modified silicon substrate layout comprising: a chemical barrier structure formed from the substrate and positioned to prevent ingress of liquid into at least a portion of the channel via the mouth.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

What is claimed is:

1. A silicon photonic device, comprising:
a semiconductor structure having a first surface; and
a substrate formed from a silicon-containing material, the substrate having a second surface bonded to the first surface of the semiconductor structure and patterned to comprise:
a waveguide;
a raised structure defining a channel between the raised structure and the waveguide, such that the first surface encloses the channel in a first direction toward the semiconductor structure and defines a mouth of the channel, the mouth being open in a second direction perpendicular to the first direction; and
a chemical barrier structure positioned to prevent ingress of liquid into at least a portion of the channel via the mouth.

2. The silicon photonic device of claim 1, wherein:
the chemical barrier structure comprises at least two protrusions extending from the raised structure to respective ends;
the at least two protrusions define at least one trap channel between the protrusions; and
the ends are separated from the waveguide by a gap,
such that liquid passing into the channel via the mouth is drawn from the gap into the trap channel, away from the waveguide, by surface tension.

3. The silicon photonic device of claim 2, wherein:
the gap is at least 100 nm.

4. The silicon photonic device of claim 2, wherein:
each protrusion of the at least two protrusions has a rectangular shape.

5. The silicon photonic device of claim 2, wherein:
each protrusion of the at least two protrusions has a tapered shape with a greater width at the raised structure than at the end.

6. The silicon photonic device of claim 1, wherein:
the chemical barrier structure comprises a wall extending between the raised structure and the waveguide.

7. The silicon photonic device of claim 6, wherein:
the wall has a thickness of no more than 200 nm.

8. The silicon photonic device of claim 6, wherein:
the wall is a first wall;
the first surface further defines a second mouth of the channel; and
the second surface of the substrate is patterned to comprise a second chemical barrier structure positioned to prevent ingress of liquid into at least the portion of the channel via the second mouth,
the second chemical barrier structure comprising a second wall parallel to the first wall.

9. The silicon photonic device of claim 6, wherein:
light propagates through the waveguide along a longitudinal axis of the waveguide; and
the wall extends from the waveguide at an angle of 60 to 120 degrees to the longitudinal axis.

10. The silicon photonic device of claim 9, wherein:
the angle is about 90 degrees.

11. The silicon photonic device of claim 9, wherein:
the angle is about 70 degrees or about 110 degrees.

12. The silicon photonic device of claim 9, wherein:
the channel is a first channel; and
the second surface of the substrate is patterned to comprise:
a second raised structure defining a second channel between the second raised structure and the waveguide, the first channel and the second channel being located on opposite sides of the waveguide; and
a second chemical barrier structure positioned to prevent ingress of liquid into at least a portion of the second channel, the second chemical barrier structure comprising a second wall, coplanar with the first wall and extending from the second raised structure to the waveguide.

13. The silicon photonic device of claim 1, wherein:
the chemical barrier structure maintains optical performance of the waveguide across a wavelength range spanning 1000 nm to 2000 nm.

14. A computer-implemented method for manufacturing a silicon photonic device, comprising:
obtaining a silicon substrate layout comprising a pattern for patterning a substrate formed from a silicon-containing material to form:
a waveguide; and
a raised structure defining a channel between the raised structure and the waveguide, such that the channel is enclosed in a first direction by a semiconductor structure, thereby defining a mouth of the channel, the mouth being open in a second direction perpendicular to the first direction; and
processing the silicon substrate layout to generate a modified silicon substrate layout comprising:
a chemical barrier structure formed from the substrate and positioned to prevent ingress of liquid into at least a portion of the channel via the mouth.

15. The computer-implemented method of claim 14, further comprising:
patterning a surface of the substrate according to the modified silicon substrate layout; and
bonding the patterned surface of the substrate to a surface of the semiconductor structure.

16. The computer-implemented method of claim 15, further comprising:
etching away a portion of the semiconductor structure to define an edge of the semiconductor structure at the mouth.

17. The computer-implemented method of claim 14, wherein:
the chemical barrier structure comprises at least two protrusions extending from the raised structure to respective ends;
the at least two protrusions define at least one trap channel between the protrusions; and
the ends are separated from the waveguide by a gap,
such that liquid passing into the channel via the mouth is drawn from the gap into the trap channel, away from the waveguide, by surface tension.

18. The computer-implemented method of claim 14, wherein:
the chemical barrier structure comprises a wall extending between the raised structure and the waveguide.

19. The computer-implemented method of claim 18, wherein:
light propagates through the waveguide along a longitudinal axis of the waveguide; and
the wall extends from the waveguide at an angle of 60 to 120 degrees to the longitudinal axis.

20. A non-transitory computer-readable storage medium, the computer-readable storage medium including instructions that when executed by a processor of a system, cause the system to perform operations comprising:
obtaining a silicon substrate layout comprising a pattern for patterning a substrate formed from a silicon-containing material to form:
a waveguide; and
a raised structure defining a channel between the raised structure and the waveguide, such that the channel is enclosed in a first direction by a semiconductor structure, thereby defining a mouth of the channel, the mouth being open in a second direction perpendicular to the first direction; and
processing the silicon substrate layout to generate a modified silicon substrate layout comprising:
a chemical barrier structure formed from the substrate and positioned to prevent ingress of liquid into at least a portion of the channel via the mouth.
